(19) United States
(12) Patent Application Publication
(10) Pub. No.: US 2011/0102408 A1
(43) Pub. Date: May 5, 2011

(54) LAYOUT OF LCD DRIVING CIRCUIT

(75) Inventors: Hyun Ho Cho, Incheon-si (KR); Myung Woo Oh, Daejeon-si (KR); Jeong Suk Park, Daejeon-si (KR); Hoon Ho Na, Daejeon-si (KR); Dae Seong Kim, Daejeon-si (KR); Dae Keun Han, Daejeon-si (KR)

(73) Assignee: SILICON WORKS CO., LTD, Daejeon-si (KR)

(21) Appl. No.: 13/000,870

(22) PCT Filed: May 22, 2009
(86) PCT No.: PCT/KR09/02695

§ 371 Date: Dec. 22, 2010

(30) Foreign Application Priority Data
Jun. 30, 2008 (KR) 10-2008-0062265

(51) Int. Cl. G09G 3/36; G09G 5/00

(52) U.S. Cl. 345/211; 345/87

(57) ABSTRACT

A layout of a liquid crystal display driving circuit is capable of minimizing an area which the layout occupies. The layout of the liquid crystal display driving circuit transmits positive analog voltages and negative analog voltages to a liquid crystal display, and includes a digital-to-analog converter (DAC) block and a buffer block. The DAC block has N/2 positive DACs generating the respective positive analog voltages corresponding to corresponding digital data using a positive reference voltage, where N is the integer, and N/2 negative DACs generating the respective negative analog voltages corresponding to corresponding digital data using a negative reference voltage. The buffer block has N/2 positive and negative buffers, which buffer the N/2 positive and negative analog voltages, and are alternately arranged. The N/2 positive and negative DACs are divided into groups one by one or in twos or more, and the groups are alternately arranged.

### BACKGROUND OF THE INVENTION

1. Field of the Invention

The present invention relates to a liquid crystal display driving circuit and, more particularly, to a layout of a liquid crystal display driving circuit, capable of minimizing an area which the layout occupies.

2. Description of the Related Art

FIG. 1 is a block diagram showing a conventional 6-channel liquid crystal display driving circuit.

Referring to FIG. 1, the liquid crystal display driving circuit 100 includes a latch block 110, a digital-to-analog converter (DAC) block 120, a buffer block 130, and a switch block 140.

The latch block 110 includes six latches that store and output digital data corresponding to six channels.

The DAC block 120 includes three P-type DACs (P DACs) and three N-type DACs (N DACs). The three P DACs generate positive analog voltages A′, C′ and E′ corresponding to digital data A, C and E output from the corresponding latches using a positive reference voltage Vrefp. The three N DACs generate negative analog voltages B′, D′ and F′ corresponding to digital data B, D and F output from the corresponding latches using a negative reference voltage Vrefn. Here, the number of bits of the digital data is n (where n is the integer).

The buffer block 130 includes three P-type buffers (P Buffers) and three N-type buffers (N Buffers). The three P Buffers buffer three positive analog voltages A′, C′ and E′ output from the three P DACs. The three N Buffers buffer three negative analog voltages B′, D′ and F′ output from the three N DACs.

Here, each P Buffer is a custom-made buffer so as to be suitable to generate analog voltage, particularly positive analog voltage, having higher amplitude compared to a predetermined amplitude of central voltage. Each N Buffer is a custom-made buffer so as to be suitable to generate analog voltage, particularly negative analog voltage, having lower amplitude compared to the predetermined amplitude of central voltage. The reason to use this custom-made buffer is for minimizing an area which the layout of a buffer circuit occupies. Since the P Buffers and the N Buffers are alternately arranged, circuitry of the switch block 140 connected with the buffer block 130 is simplified.

The switch block 140 sorts the analog voltages A′ to F′ buffered by the buffer block 130 into positive analog voltages and negative analog voltages, and then alternately transmits them to a liquid crystal display panel (not shown). In other words, the switch block causes polarities of the digital data transmitted to the liquid crystal display panel to continue to be switched.

FIG. 2 shows the layout of a conventional 12-channel liquid crystal display driving circuit.

Referring to FIG. 2, the 12-channel liquid crystal display driving circuit is identical to a combination of the two 6-channel liquid crystal display driving circuits shown in FIG. 1, and thus components thereof will not be described.

The P DACs are used to generate the positive analog voltages, and the N DACs are used to generate the negative analog voltages. As such, in the case in which these DACs are realized using complementary metal oxide Silicon(CMOS), each DAC is generally realized using only one of P-type transistors and N-type transistors.

In FIG. 2, it is taken by way of example that the P DACs are realized using P-type transistors formed in an N-type well, and that the N DACs are realized using N-type transistors formed in a P-type well. When the layout is done, a constant interval is required between patterns formed in or on each substrate. This is generally called a design rule. Consequently, when a pattern becomes adjacent to another pattern, an interval between the patterns is defined by the design rule. Due to this design rule, an area which a layout occupies will increase.

FIG. 3 shows a detailed transistor-level layout of the DAC block shown in FIG. 2.

In FIG. 3, a total of 12 channels are shown on the upper side, and only 6 middle channels of the 12 upper channels is roughly enlarged on the lower side. Among symbols, a refers to an interval between a transistor and another transistor, b refers to an interval between a transistor and a guard ring, and c refers to an interval between a guard ring and a boundary of a well including the guard ring.

In the case of the 6 channels shown on the lower side of FIG. 3, the numbers of a, b and c are 6, 12 and 12 respectively, and thus a total of 30 interval points exist. In the case of the 12 channels shown on the upper side of FIG. 3, a total of 60 interval points exist, which are twice the 30 interval points for the 6 channels.

As shown in FIG. 3, in the case of the conventional liquid crystal display driving circuit, the P-type wells and the N-type wells are alternately arranged, and the N-type MOS transistors and the P-type transistors are alternately arranged in groups within the corresponding wells. For this reason, unnecessary ones of the interval points existing between these components become too much.

### SUMMARY OF THE INVENTION

Accordingly, the present invention has been made keeping in mind the above problems occurring in the related art, and embodiments of the present invention provide a layout of a liquid crystal display driving circuit, capable of minimizing an area which the layout occupies.

According to an aspect of the present invention, there is provided a layout of a liquid crystal display driving circuit, which transmits positive analog voltages and negative analog voltages to a liquid crystal display, and includes a digital-to-analog converter (DAC) block and a buffer block. The DAC block includes N/2 positive DACs generating the respective positive analog voltages corresponding to corresponding digital data using a positive reference voltage, where N is the integer, and N/2 negative DACs generating the respective negative analog voltages corresponding to corresponding digital data using a negative reference voltage. The buffer block includes N/2 positive buffers buffering the N/2 positive analog voltages and N/2 negative buffers buffering the N/2 negative analog voltages, both of which are alternately arranged. The N/2 positive DACs are divided into groups one by one or in twos or more. The N/2 negative DACs are divided into groups one by one or in twos or more. The groups are alternately arranged.

According to embodiments of the present invention, the layout of the liquid crystal display driving circuit reduces an area which the liquid crystal display driving circuit occupies in the layout.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a block diagram showing a conventional 6-channel liquid crystal display driving circuit;

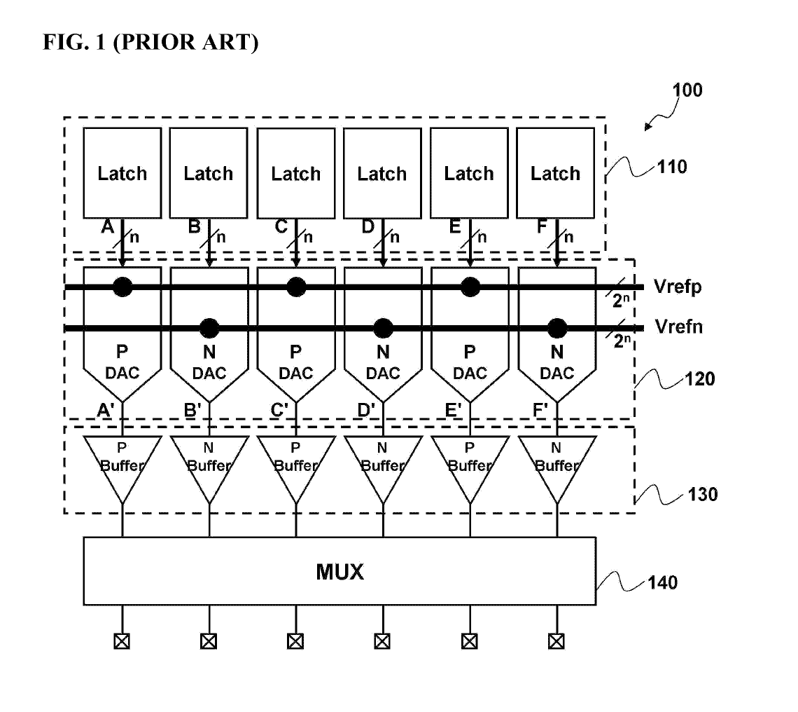

FIG. 2 shows the layout of a conventional 12-channel liquid crystal display driving circuit;

FIG. 3 shows a detailed transistor-level layout of the DAC block shown in FIG. 2;

FIG. 4 shows the layout of a liquid crystal display driving circuit according to an embodiment of the present invention;

FIG. 5 shows the layout of a liquid crystal display driving circuit according to another embodiment of the present invention;

FIG. 6 shows the layout of a liquid crystal display driving circuit according to a third embodiment of the present invention;

FIG. 7 shows the layout of a liquid crystal display driving circuit according to a fourth embodiment of the present invention;

FIG. 8 shows a detailed transistor-level layout of the DAC block shown in FIG. 4;

FIG. 9 shows a detailed transistor-level layout of the DAC block shown in FIG. 5;

FIG. 10 shows a detailed transistor-level layout of the DAC block shown in FIG. 6;

FIG. 11 shows a detailed transistor-level layout of the DAC block shown in FIG. 7; and

FIG. 12 shows comparison between transverse sizes according to DAC arrangement.

### DETAILED DESCRIPTION OF THE INVENTION

Reference will now be made in greater detail to exemplary embodiments of the invention with reference to the accompanying drawings. Wherever possible, the same reference numerals will be used throughout the drawings and the description to refer to the same or like parts.

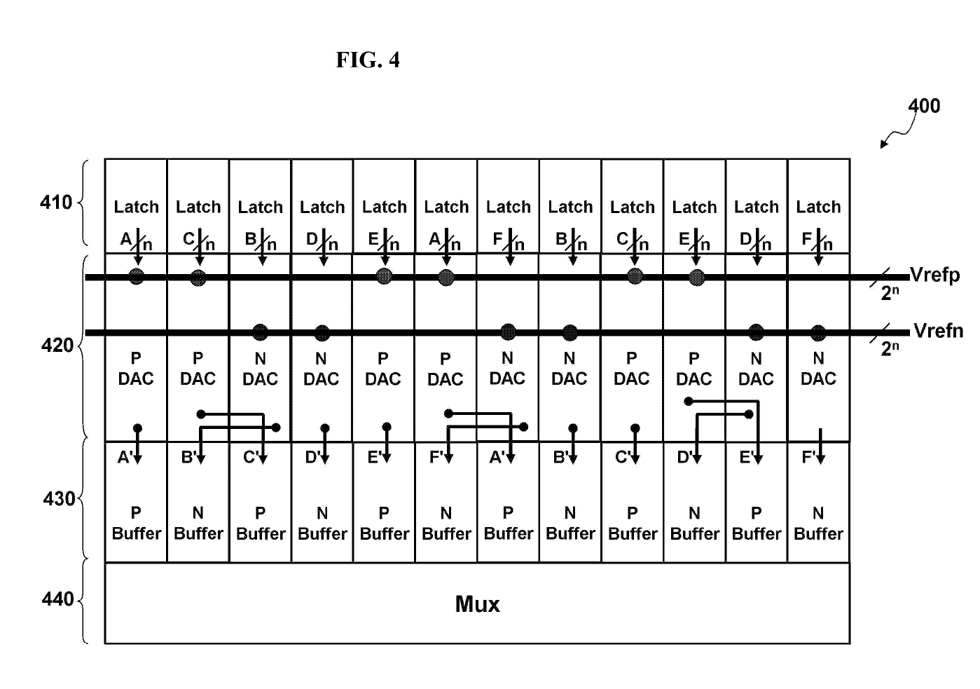

FIG. 4 shows the layout of a liquid crystal display driving circuit according to an embodiment of the present invention.

Referring to FIG. 4, the liquid crystal display driving circuit 400 includes a latch block 410, a digital-to-analog converter (DAC) block 420, a buffer block 430, and a switch block 440.

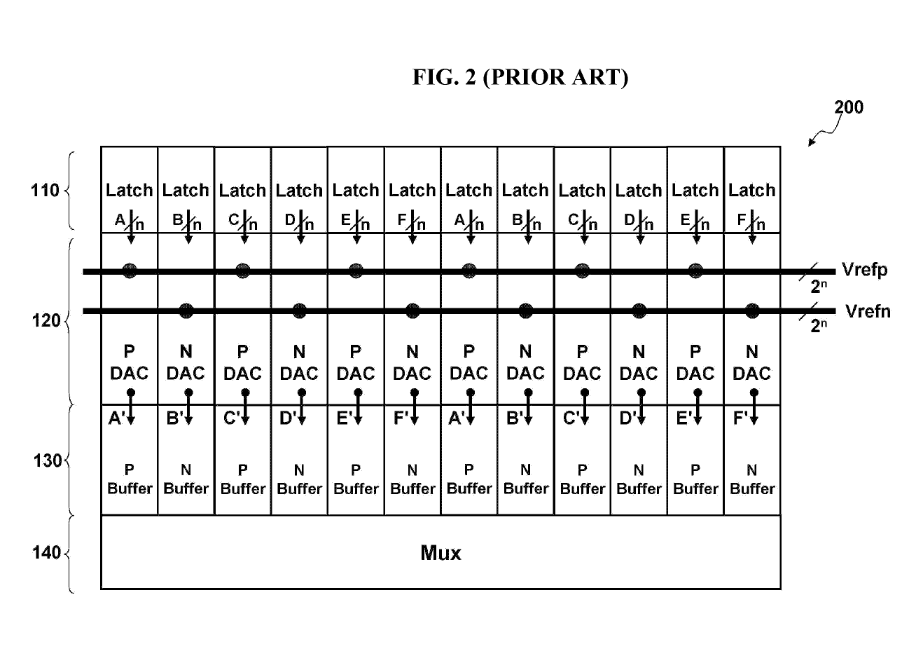

The buffer block 430 and the switch block 440 have the same arrangement as those of the conventional liquid crystal display driving circuit 200 shown in FIG. 2.

The latch block 410 is configured to output digital data in order of A, C, B, D, E, A, F, B, C, E, D and F. The DAC block 420 generates analog voltages A′, C′, B′, D′, E′, A′, F′, B′, C′, E′, D′ and F′ according to the order of the digital data A, C, B, D, E, A, F, B, C, E, D and F output from the latch block 410.

The DAC block 420 is configured in such a manner that two P-type DACs, which receive two digital data A and C respectively and generate positive analog voltages A′ and C′ corresponding to the received digital data, and two N-type DACs, which receive two digital data B and D respectively and generate negative analog voltages B′ and D′ corresponding to the received digital data, are arranged in order. Seen as a whole, the two P-type DACs and the two N-type DACs become one group, and these groups are alternately arranged.

Since 12 buffers constituting the buffer block 430 are configured in such a manner that P-type and N-type buffers are alternately arranged, the analog voltages A′, C′, B′, D′, E′, A′, F′, B′, C′, E′, D′ and F′ output from the DAC block 420 should also be transmitted to the buffers corresponding to the analog voltages.

The positive analog voltage A′ output from the P-type DAC that is the first DAC may be directly transmitted to the P-type buffer that is the first buffer arranged. Since the positive analog voltage C′ output from the P-type DAC that is the second DAC should be transmitted to the P-type buffer that is the third buffer arranged, a metal line along which the positive analog voltage C′ is transmitted has one bent point.

Since the negative analog voltage B′ output from the N-type DAC that is the third DAC should be transmitted to the N-type buffer that is the second buffer arranged, a metal line along which the negative analog voltage B′ is transmitted has one bent point. Since the negative analog voltage D′ output from the N-type DAC that is the fourth DAC should be transmitted to the N-type buffer that is the fourth buffer arranged, a metal line along which the negative analog voltage D′ is transmitted may be directly connected without any bent point.

Since the positive analog voltage E′ output from the P-type DAC that is the fifth DAC should be transmitted to the P-type buffer that is the fifth buffer arranged, a metal line along which the positive analog voltage E′ is transmitted may be directly connected without any bent point. Since the positive analog voltage A′ output from the P-type DAC that is the sixth DAC should be transmitted to the P-type buffer that is the seventh buffer arranged, a metal line along which the positive analog voltage A′ is transmitted has one bent point.

Since the negative analog voltage F′ output from the N-type DAC that is the seventh DAC should be transmitted to the N-type buffer that is the sixth buffer arranged, a metal line along which the negative analog voltage F′ is transmitted has one bent point. This continuously repeated structure can be understood although it is no longer described. As such, description of FIG. 4 will be omitted.

To sum up, the metal lines having a linear shape or a bent shape are required to transmit the analog voltages output from the DAC block 420 to the corresponding buffers according to the arrangement of the latch block 410 and the DAC block 420.

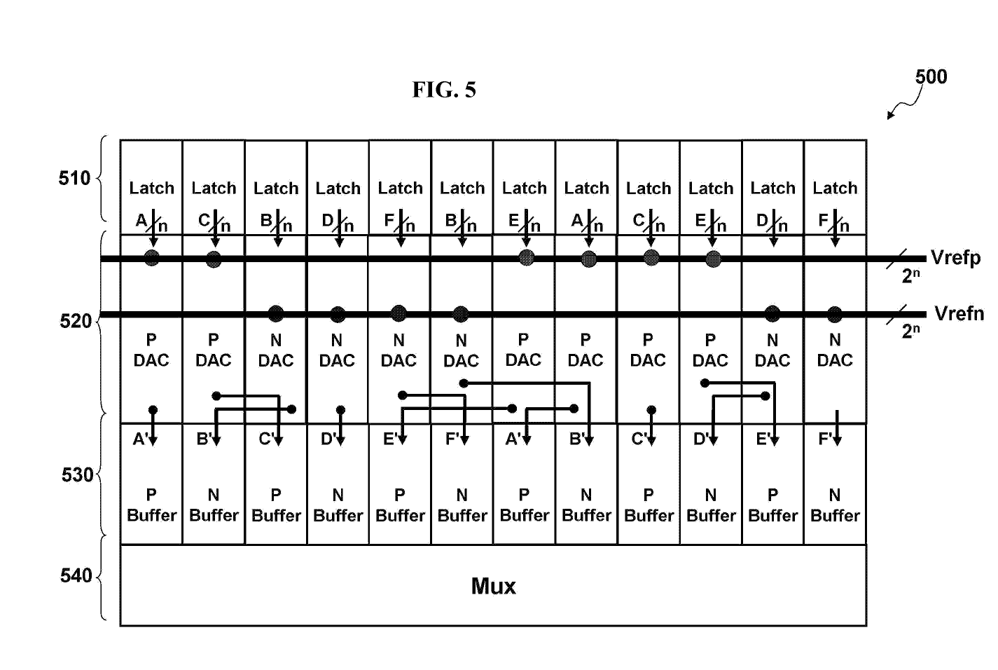

FIG. 5 shows the layout of a liquid crystal display driving circuit according to another embodiment of the present invention.

Referring to FIG. 5, a latch block 510 is configured to output digital data in order of A, C, B, D, F, B, E, A, C, E, D and F. A DAC block 520 generates analog voltages A′, C′, B′, D′, F′, B′, E′, A′, C′, E′, D′ and F′ according to the order of the digital data A, C, B, D, F, B, E, A, C, E, D and F output from the latch block 510.

The DAC block 520 is configured in such a manner that two P-type DACs, which receive two digital data A and C respectively and generate positive analog voltages A′ and C′ corresponding to the received digital data, and four N-type DACs, which receive four digital data B, D, F and B respectively and generate negative analog voltages B′, D′, F′ and B′ corresponding to the received digital data, are arranged in order. Continuously, four P-type DACs, which generate positive analog voltages E′, A′, C′ and E′ corresponding to four digital data E, A, C and E, and two N-type DACs, which generate negative analog voltages D′ and F′ corresponding to two digital data D and F, are provided.

Seen as a whole, the two P-type DACs, the four N-type DACs, the four P-type DACs, and the two N-type DACs are arranged in that order. Metal lines having a linear shape or a bent shape are required to transmit the analog voltages output from the DAC block 520 to the corresponding buffers 530 according to the arrangement of the latch block 510 and the DAC block 520.

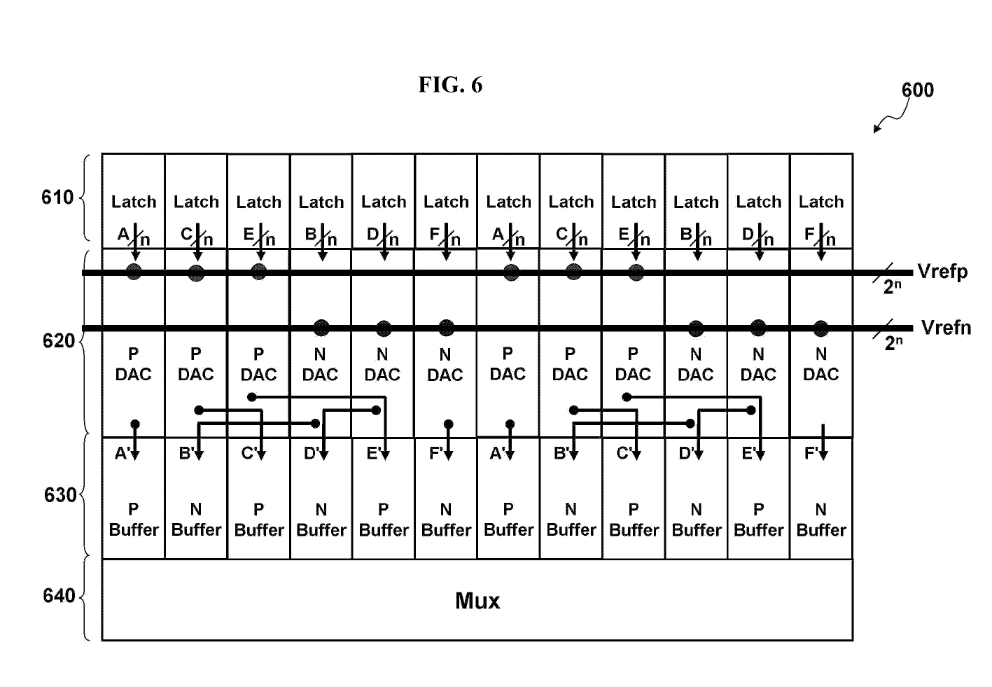

FIG. 6 shows the layout of a liquid crystal display driving circuit according to a third embodiment of the present invention.

Referring to FIG. 6, a latch block 610 is configured to output digital data in order of A, C, E, B, D, F, A, C, E, B, D and F. A DAC block 620 generates analog voltages A′, C′, E′, B′, D′, F′, A′, C′, E′, B′, D′ and F′ according to the order of the digital data A, C, E, B, D, F, A, C, E, B, D and F output from the latch block 610.

The DAC block 620 is configured in such a manner that three P-type DACs, which receive three digital data A, C and E respectively and generate positive analog voltages A′, C′ and E′ corresponding to the received digital data, and three N-type DACs, which receive three digital data B, D and F respectively and generate negative analog voltages B′, D′ and F′ corresponding to the received digital data, are arranged in order. The DAC block 620 further includes three P-type DACs, which generate positive analog voltages A′, C′ and E′ corresponding to three digital data A, C and E, and three N-type DACs, which generate negative analog voltages B′, D′ and F′ corresponding to three digital data B, D and F.

Seen as a whole, the three P-type DACs and the three N-type DACs are alternately arranged. Like the layouts shown in FIGS. 4 and 5, the layout shown in FIG. 6 requires metal lines having a linear shape or a bent shape to transmit the analog voltages output from the DAC block 620 to the corresponding buffers 630 according to the arrangement of the latch block 610 and the DAC block 620.

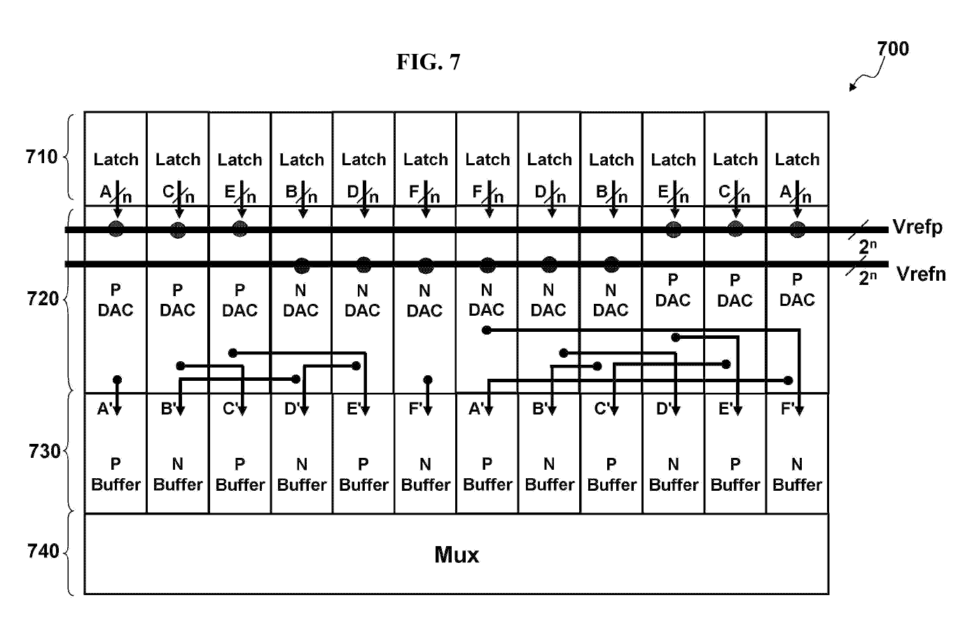

FIG. 7 shows the layout of a liquid crystal display driving circuit according to a fourth embodiment of the present invention.

Referring to FIG. 7, a latch block 710 is configured to output digital data in order of A, C, E, B, D, F, F, D, B, E, C and A. A DAC block 720 generates analog voltages A′, C′, E′, B′, D′, F′, F′, D′, B′, E′, C′ and A′ according to the order of the digital data A, C, E, B, D, F, F, D, B, E, C and A output from the latch block 710.

The DAC block 720 includes three P-type DACs, which receive three digital data A, C and E respectively and generate positive analog voltages A′, C′ and E′ corresponding to the received digital data, six N-type DACs, which receive three digital data B, D, F, F, D and B respectively and generate negative analog voltages B′, D′, F′, F′, D′ and B′ corresponding to the received digital data, and three P-type DACs, which receive three digital data E, C and A respectively and generate positive analog voltages E′, C′ and A′ corresponding to the received digital data.

Like the layouts shown in FIGS. 4 through 6, metal lines having a linear shape or a bent shape are required to transmit the analog voltages output from the DAC block 720 to the corresponding buffers 730 according to the arrangement of the latch block 710 and the DAC block 720.

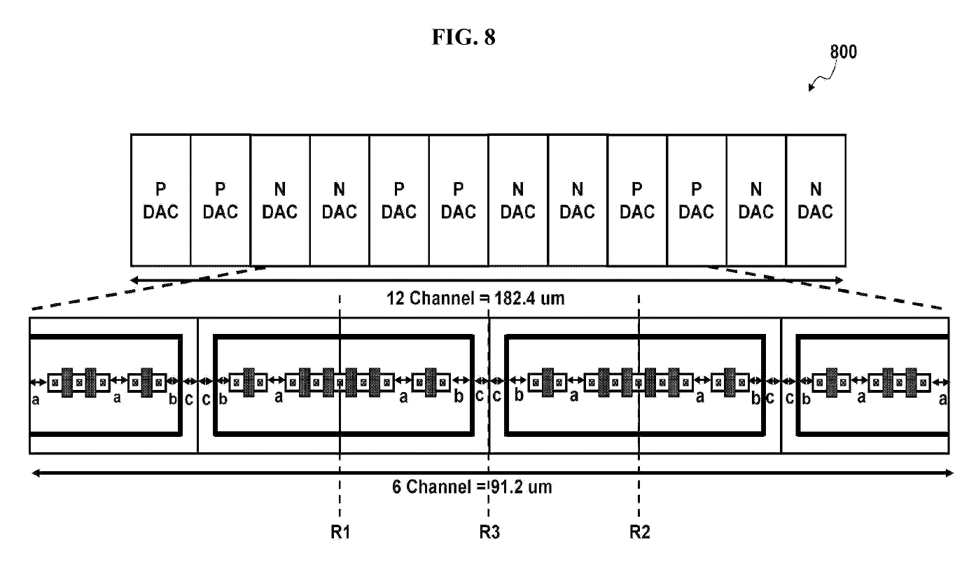

FIG. 8 shows a detailed transistor-level layout of the DAC block shown in FIG. 4.

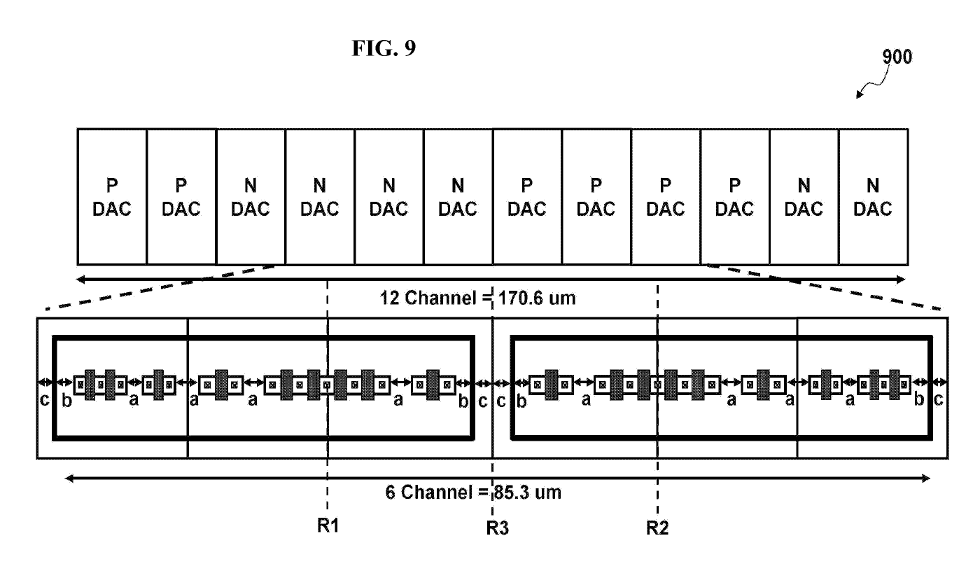

Among symbols represented in FIG. 8, a refers to an interval between a transistor and another transistor, b refers to an interval between a transistor and a guard ring, and c refers to an interval between a guard ring and a boundary of a well including the guard ring. This definition is equally applied to symbols of FIGS. 9 through 11, which will be described below, as long as no reference is made separately.

Referring to FIG. 8, in the case of 6 channels, the numbers of a, b and c are 8, 6 and 6 respectively, and thus a total of 20 interval points exist. Expanding the 6 channels up to 12 channels, a total of 40 interval points exist.

FIG. 9 shows a detailed transistor-level layout of the DAC block shown in FIG. 5.

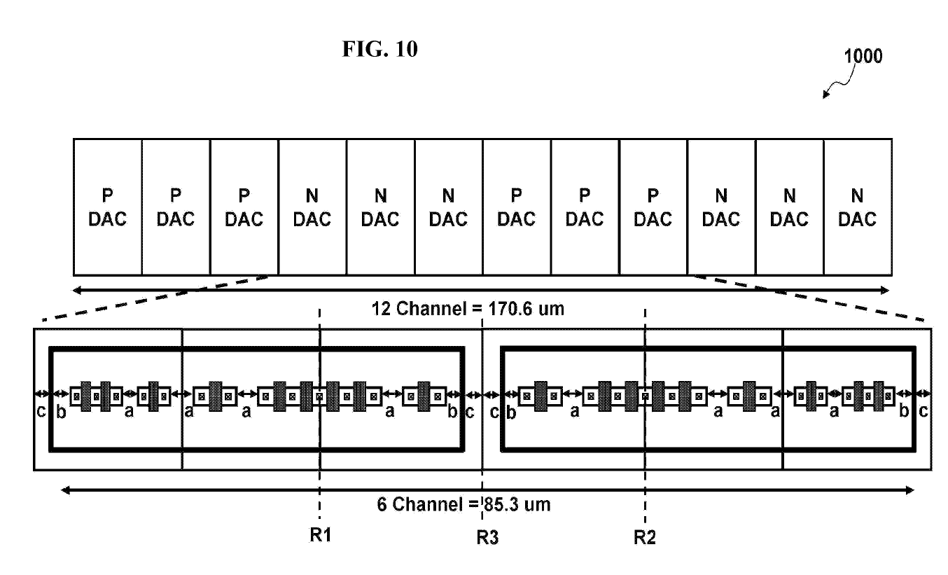

FIG. 10 shows a detailed transistor-level layout of the DAC block shown in FIG. 6.

Referring to FIGS. 9 and 10, in the case of 6 channels, the numbers of a, b and c are 8, 4 and 4 respectively, and thus a total of 16 interval points exist. Expanding the 6 channels up to 12 channels, a total of 32 interval points exist.

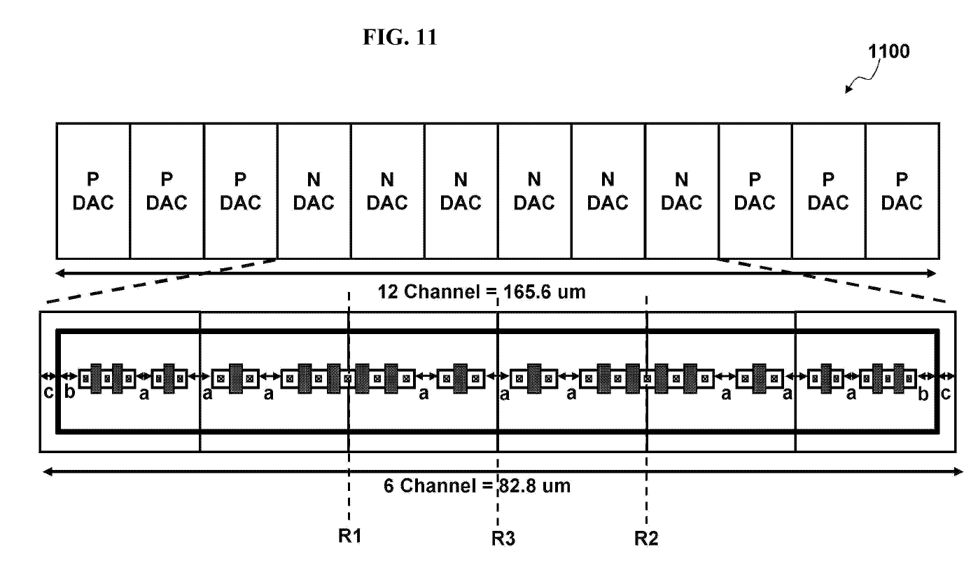

FIG. 11 shows a detailed transistor-level layout of the DAC block shown in FIG. 7.

Referring to FIG. 11, in the case of 6 channels, the numbers of a, b and c are 9, 2 and 2 respectively, and thus a total of 13 interval points exist. Expanding the 6 channels up to 12 channels, a total of 26 interval points exist.

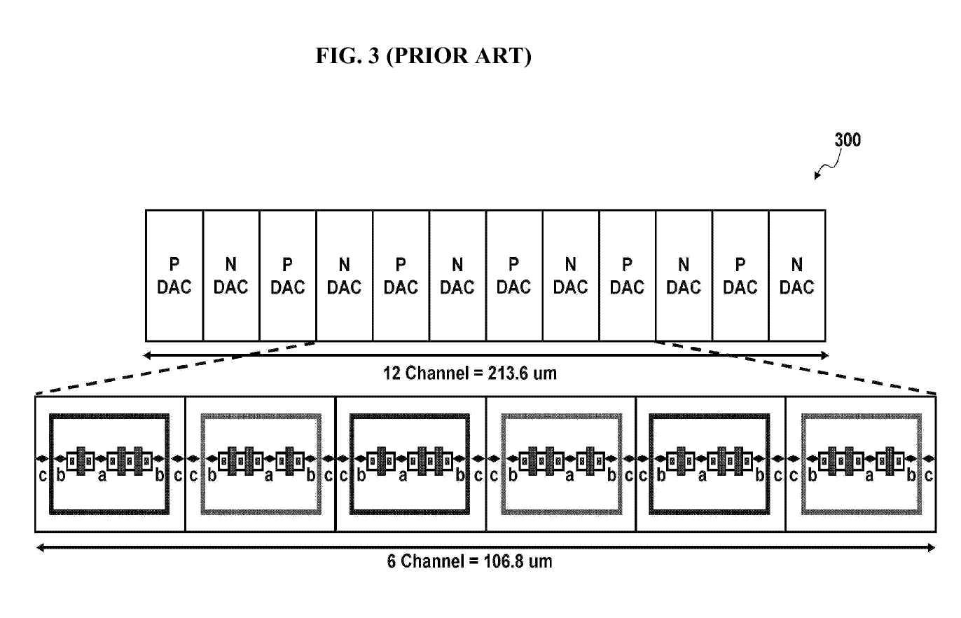

In the case of the conventional DAC block shown in FIG. 3, the numbers of a, b and c are 6, 12 and 12 respectively, and thus a total of 30 interval points exist. When the 6 channels are expanded up to the 12 channels, a total of 60 interval points exist. In this aspect, it can be seen from FIGS. 8 through 11 that the number of the interval points of the inventive layout is relatively small.

If horizontal lengths of estimated layouts are actually compared with each other, a difference between the numbers of the interval points as described above can be more distinctly recognized.

In the case of the 6 channels, the conventional layout (FIG. 3) requires 106.8 μm, whereas the inventive layouts (FIGS. 8 through 11) require 91.2 μm, 85.3 μm, 85.3 μm, and 82.8 μm, respectively.

Hereinafter, the transistor-level layout shown on the lower sides of FIGS. 8 through 11 will be described.

Referring to FIG. 8, in the case where DACs are grouped in twos, the transistors embodied in the DACs of the same type grouped together are symmetrically arranged with respect to contact plane R1 and R2 between the DACs. In detail, in the case of the second and third positive DACs, and in the case of the following fourth and fifth negative DACs, the transistors constituting each DAC are symmetrically arranged with respect to the contact planes R1 and R2. Further, in terms of the arrangement of the transistors, it can be seen that, as described above, inside the positive DACs, inside the negative DACs, and between the grouped positive DACs and the grouped negative DACs, the arrangement of the transistors that are symmetrical about a contact plane R3 of these DACs is formed.

Referring to FIGS. 9 and 10, in the case of the three negative DACs shown on the left lower side, the transistors embodied in the last two DACs are symmetrically arranged with respect to a contact plane R1. The transistors constituting the first two DACs of the positive DACs are symmetrically arranged with respect to a contact plane R2. Further, the transistors constituting two DAC groups, i.e. a group of negative DACs and a group of positive DACs, are symmetrically arranged with respect to a contact plane R3 between the two DAC groups.

Referring to FIG. 11, both the transistors constituting the second and third negative DACs from the left side and the transistors constituting the fourth and fifth positive DACs from the left side are arranged so as to be symmetrical about respective contact planes R1 and R2. Further, the layout is done in such a manner that the arrangement of the transistors constituting the three DACs of the left side and the arrangement of the transistors constituting the three DACs of the right side are symmetrical about a contact plane R3.

Referring to FIGS. 8 through 11, if the layout is done so as to provide at least one structure where the arrangement of the transistors constituting the group of negative DACs and the arrangement of the transistors constituting the group of positive DACs are symmetrical with each other, or simultaneously if the layout is done so as to be symmetrical between the group of negative DACs and the group of positive DACs, an entire area of the layout consumed for the DAC block will be minimized.

Particularly, the reference voltage Vrefp or negative voltage Vrefn is preferably applied to a diffusion region abutting on the two contact planes R1 and R2.

However, if one DAC unit cell is used by arrangement of a step and repeat form, it is apparent that this structure will increase the area consumed for the layout compared to the symmetrical structure as described above.

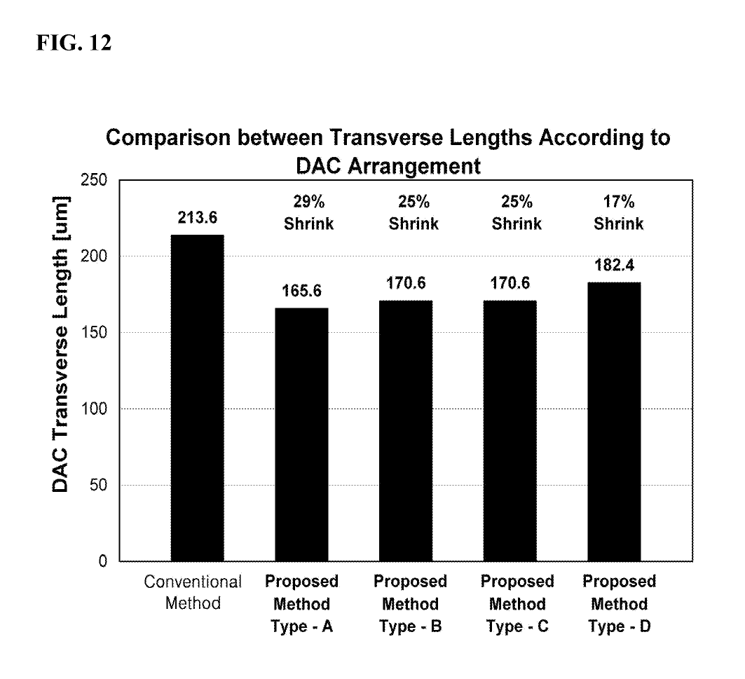

FIG. 12 shows comparison between transverse sizes according to DAC arrangement.

Referring to FIG. 12, in the case of 12 channels, the conventional layout (FIG. 3) requires a length of 213.6 μm, while the inventive layouts (FIGS. 8 through 11) require lengths of 182.4 μm (FIG. 8, type D), 170.6 μm (FIG. 9, type B), 170.6 μm (FIG. 10, type C), and 165.6 μm (FIG. 11, type A), respectively.

As described above, when the latch block and DAC block of the liquid crystal display driving circuit are arranged, it can be seen that, instead of alternate arrangement of P type and N type as in the prior art, a method of combining P type and N type in numbers, defining each combination as one group, and alternately arranging these groups can improve efficiency of the layout.

In the aforementioned embodiments, both the P-type DACs and the N-type DACs have been described as being combined in twos or more. However, one P-type DAC and one N-type DAC may be included. Taking the 12 channel by way of example, the P-type DACs may be one group in which one, two and three P-type DACs are repeated. Similarly, the N-type DACs may be one group in which one, two and three N-type DACs are repeated.

Although exemplary embodiments of the present invention have been described for illustrative purposes, those skilled in the art will appreciate that various modifications, additions and substitutions are possible, without departing from the scope and spirit of the invention as disclosed in the accompanying claims.

1. A layout of a liquid crystal display driving circuit, which transmits positive analog voltages and negative analog voltages to a liquid crystal display, the layout comprising:
a digital-to-analog converter (DAC) block having N/2 positive DACs generating the respective positive analog voltages corresponding to corresponding digital data using a positive reference voltage, where N is the integer, and N/2 negative DACs generating the respective negative analog voltages corresponding to corresponding digital data using a negative reference voltage; and
a buffer block in which N/2 positive buffers buffering the N/2 positive analog voltages and N/2 negative buffers buffering the N/2 negative analog voltages are alternately arranged,
wherein the N/2 positive DACs are divided into groups one by one or in twos or more, the N/2 negative DACs are divided into groups one by one or in twos or more, and the groups are alternately arranged.

2. The layout as set forth in claim 1, wherein the N/2 positive analog voltages and the N/2 negative analog voltages are alternately transmitted to the respective buffers in order.

3. The layout as set forth in claim 1, further comprising a latch block having N latches storing the digital data.

4. The layout as set forth in claim 3, wherein the N latches are arranged in the same order as the N DACs corresponding thereto.

5. The layout as set forth in claim 1, further comprising a switch block multiplexing the buffered positive and negative analog voltages output from the buffer block.

6. The layout as set forth in claim 5, wherein the switch block sorts the buffered positive and negative analog voltages into the positive analog voltages and the negative analog voltages, and alternately supplies the sorted voltages to a panel of the liquid crystal display.

7. The layout as set forth in claim 1, wherein at least one of the layout of transistors between the neighboring negative DACs forming the group of negative DACs and the layout of transistors between the neighboring positive DACs forming the group of positive DACs have symmetry.

8. The layout as set forth in claim 7, wherein the layout of the transistors embodied in the group of negative DACs and the layout of the transistors embodied in the group of positive DACs have symmetry.

9. The layout as set forth in claim 7, wherein:
the negative reference voltage is applied to a diffusion region abutting on at least one plane commonly shared by the transistors when a symmetrical structure is formed between the transistors embodied in the group of negative DACs; and
the positive reference voltage is applied to a diffusion region abutting on at least one plane commonly shared by the transistors when a symmetrical structure is formed between the transistors embodied in the group of positive DACs.
